(19) United States
(12) Patent Application Publication
(10) Pub. No.: US 2010/0216960 A1
(43) Pub. Date: Aug. 26, 2010

(54) Polycarboxylate Ether As A Dispersing Agent For Inorganic Pigment Formulations

(75) Inventors: Hendrik Ahrens, Kriftel (DE); Carsten Schaefer, Muehldorf (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/678,816

(22) PCT Filed: Sep. 18, 2008
(86) PCT No.: PCT/EP2008/007783

§ 371 Date: Mar. 18, 2010

(30) Foreign Application Priority Data
Sep. 21, 2007 (DE) 102007045230.8

(51) Int. Cl. C08F 220/26

(52) U.S. Cl. 526/278; 526/287; 526/318.2; 526/320

(57) ABSTRACT

The invention relates to the use of macromonomers produced using DMC catalyst for the production of polycarboxylate ethers obtainable by polymerization of the monomers (A), (B), and (C), wherein (A) is a monomer of the formula (I),

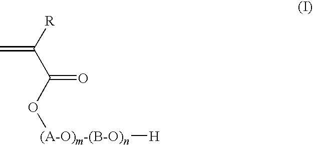

where A is C₂ to C₄ alkylene, B is a C₂ to C₄ alkylene that is different from A, R is hydrogen or methyl, m is a number from 1 to 500, n is a number from 1 to 500, (B) is an ethylenically unsaturated monomer containing at least one carbonic acid function, (C) is a further ethylenically unsaturated monomer that is different from (A) and (B).

The present invention relates to polycarboxylate ethers and to the preparation and use thereof as dispersants for inorganic pigment suspensions, plasticizers and superplasticizers for hydraulic cement systems, concrete, mortar, gypsum suspensions and anhydrous calcium sulfate binder formulations, for ceramic materials comprising clays, kaolins, feldspars and quartz minerals and for pigment preparations of inorganic white and colored pigments in the paint and coating industry, and leather industry, and as scale inhibitors, dispersants and sequestering agents in the detergent and cleaning agent industry and water treatment.

Solid suspensions usually contain dispersants or plasticizers for fluidizing and dispersing inorganic solids. Such solids may be cement, gypsum, calcium sulfate hemihydrate, fly ash, kaolin in the building industry, titanium dioxide, calcium carbonate, talc, barium sulfate, zinc sulfite, bismuth vanadate, iron oxide pigments, chromium dioxide, cobalt spinel pigments and other inorganic colored pigments in the paint and coating industry. Dispersants together with sodium carbonate and/or waterglass are also added to ceramic materials comprising clays, kaolins, feldspars and quartz minerals, in order to permit processability and press the green compact into the plaster mold.

Low molecular weight polymers of acrylic acid or copolymers of acrylic acid and maleic acid and the sodium, potassium or ammonium salts thereof are usually used for dispersing kaolin, titanium dioxide and calcium carbonate.

In the building industry, superplasticizers are usually used for plasticizing the concretes for the production of floor coverings, precast concrete, for ready-mixed concrete and lightweight concrete.

Sodium ligninsulfonate is a customary superplasticizer for cement in hydraulically setting building material compositions and for calcium sulfate hemihydrate in renders, masonry mortar materials, plaster laths and for anhydrite screeds.

DE-A-1238831 describes a dispersant, which is prepared by condensation of naphthalenesulfonic acid derivatives and formaldehyde, for cement.

DE-A-1671017 describes the use of melamine resins containing sulfo groups as superplasticizers for concrete.

DE-A-2948698 describes hydraulic mortars for screeds, which contain superplasticizers based on melamine-formaldehyde condensates and/or sulfonated formaldehyde-naphthalene condensates and/or ligninsulfonate and, as binders, Portland cement, clay-containing lime marl, clay and soft-fired clinker ground together.

DE-A-3530258 describes the use of water-soluble sodium naphthalenesulfonate-formaldehyde condensates as admixtures for inorganic binders and building materials. These admixtures are described for improving the flowability of the binders, such as, for example, cement, anhydrite or gypsum, and the building materials produced therewith.

In addition to the purely anionic dispersants which contain substantially carboxyl and sulfo groups, weakly anionic comb polymers which usually carry anionic charges on the main chain and contain nonionic polyalkylene glycol side chains are described.

WO-01/96007 describes these weakly anionic dispersants and grinding auxiliaries for aqueous mineral suspensions which are prepared by free radical polymerization of monomers containing vinyl groups and which contain polyalkylene oxide groups as a main component.

DE-A-19513126 and DE-A-19834173 describe copolymers based on unsaturated dicarboxylic acid derivatives and oxyalkylene glycol alkenyl ethers and the use thereof as admixtures for hydraulic binders, in particular cement.

DE-A-10017667 describes the use of similar copolymers with vinyl-functionalized polyethers for the preparation of aqueous pigment preparations. These copolymers are prepared by free radical polymerization of, inter alia, vinylpolyalkylene glycol ethers and maleic anhydride and further monomers and are suitable for dispersing organic and inorganic pigments and fillers and for the preparation of pigment concentrates, pastes and preparations.

The aim of the addition of superplasticizers in the building industry is either to increase the plasticity of the concrete or to reduce the amount of water required for the mixture comprising cement slurry, fly ash and aggregates under the same processing condition.

WO-99/010407 discloses a process for the preparation of copolymers from alkoxylated (meth)acrylic acid and ethylenically unsaturated carboxylic acids.

EP-A-1 197 536 discloses graft copolymers which can be used as a pigment dispersant. They consist of a hydrophobic main chain onto which alkoxylated (meth)acrylic acid is grafted.

EP-A-0 311 157 discloses copolymers of alkoxylated (meth)acrylic acid, (meth)acrylic acid and styrene derivatives, which can be used as dispersant.

It has been found that superplasticizers based on ligninsulfonate, melamine sulfonate and polynaphthalenesulfonate are inferior to the weakly anionic, polyalkylene glycol ether-containing copolymers in their efficiency. These copolymers are also designated as polycarboxylate ethers (PCE) in the building industry. The information brochure “Modern Superplasticisers in Concrete Technology, January 2007” of the Verein Deutsche Bauchemie e.V., Frankfurt am Main, describes the use and the advantages of these polycarboxylate ethers.

Polycarboxylate ethers disperse the inorganic pigment particles not only via electrostatic charge build-up owing to the anionic groups present on the main chain (carboxylate groups, sulfonate groups) but additionally stabilize the dispersed particles by steric effects owing to the polyalkylene glycol ether side chains which form a stabilizing protective layer around the pigment particle by absorption of water molecules.

As a result, either the required amount of water for establishing a certain consistency can be reduced compared with the classical superplasticizers or the plasticity of the moist building material mixture is reduced by the addition of the polycarboxylate ethers to such an extent that self-compacting concrete can be produced at low water/cement ratios. The use of the carboxylate ethers also permits the production of ready-mixed concrete which remains pumpable over relatively long periods or the production of high-strength concretes by establishing a low water/cement ratio.

It is therefore not surprising that the industry is still searching for suitable polymers which are suitable for use as concrete plasticizers and dispersants for inorganic pigments.

WO-02/066528 describes such a dispersant which is suitable as a water-reducing auxiliary for concrete. In particular, macromonomers which are available by alkoxylation of hydroxyalkyl acrylates and methacrylates in the presence of DMC (double metal cyanide) catalysts are used for the preparation of the dispersant.

U.S. Pat. No. 5,777,177 and U.S. Pat. No. 5,854,386 describe the use of DMC catalysts for the alkoxylation of starter molecules.

It was accordingly an object of the present invention to provide improved polymers which are suitable for use as concrete plasticizers and dispersants for inorganic pigments.

The invention relates to the use of macromonomers, prepared using DMC catalysts, for the preparation of polycarboxylate ethers, obtainable by polymerization of the monomers (A), (B) and (C),

(A) a monomer of the formula (I)

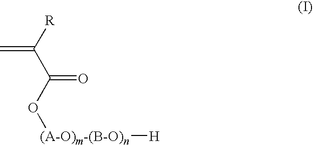

in which

A is C₂- to C₄-alkylene,

B is a C₂- to C₄-alkylene differing from A,

R is hydrogen or methyl,

m is a number from 1 to 500,

n is a number from 1 to 500,

(B) being an ethylenically unsaturated monomer which contains at least one carboxyl function,

(C) being a further, water-soluble, ethylenically unsaturated monomer differing from (A) and (B).

The proportion by weight of the monomers is preferably from 35 to 99% for the macromonomer (A), from 0.5 to 45% for the monomer (B), and from 0.5 to 20% for the monomer (C).

The alkylene oxide units (A-O)ₘ and (B-O)ₙ can be arranged either randomly or, as in the case of a preferred embodiment, blockwise. In a preferred embodiment, (A-O)ₘ are propylene oxide units and (B-O)ₙ are ethylene oxide units, or (A-O)ₘ are ethylene oxide units and (B-O)ₙ are propylene oxide units, the molar proportion of the ethylene oxide units preferably being from 50 to 99%, in particular from 60 to 99%, particularly preferably from 70 to 99%, based on the sum (100%) of the ethylene oxide and propylene oxide units.

m is preferably a number from 1 to 150, in particular from 2 to 10. n is preferably a number from 3 to 300, in particular from 5 to 150. The sum of the alkylene oxide units n +m is preferably from 2 to 500, particularly preferably from 10 to 150.

The preparation, according to the invention, of the macromonomers (A) is effected by reacting conjugated unsaturated acids or reactive derivatives, such as conjugated unsaturated hydroxyalkyl esters, with alkylene oxides in the presence of so-called DMC catalysts (double metal cyanide catalysts). These catalysts have, for example, the formula Zn₃[Co(CN)₆]₂.xZnCl₂.yH₂O.z glyme where x=from 0.2 to 3, y=from 1 to 10 and z=from 0.5 to 10, as disclosed in EP-B-0 555 053. Suitable DMC catalysts having other complex ligands are also known in the literature. Their preparation and composition are described, inter alia, in EP-A-1 244 519, EP-A-0 761 708, EP-A-0 654 302 and EP-A-1 276 563. In particular, the DMC catalysts described in Example 2 of EP-A-1 276 563 are suitable.

The monomers (B) include in particular monoethylenically unsaturated monomers.

Examples of these are monoethylenically unsaturated mono- and dicarboxylic acids having 3 to 8 carbon atoms, such as acrylic acid, methacrylic acid, crotonic acid, isocrotonic acid, maleic acid and fumaric acid.

The monomers (C) include monoethylenically unsaturated sulfonic acids and phosphonic acids and salts thereof, in particular alkali metal salts thereof, such as vinylsulfonic acid, allylsulfonic acid, methallylsulfonic acid, styrenesulfonic acid, 2-acryloyloxyethanesulfonic acid, 2-acrylamido-2-methylpropanesulfonic acid, vinylphosphonic acid, allylphosphonic acid, 2-acryloyloxyethanephosphonic acid and 2-acrylamido-2-methylpropanephosphonic acid. The monomers (C) further include monoallylpolyalkylene glycols. Monomer (C) is water-soluble.

The copolymer according to the invention may have customary terminal groups which form by the initiation of the free radical polymerization or by chain-transfer reactions or by chain termination reactions, for example a proton, a group from a free radical initiator or a sulfur-containing group from a chain-transfer agent.

The polycarboxylate ethers according to the invention preferably have a molecular weight of from 10³ g/mol to 10⁹ g/mol.

A substantial property which distinguishes the polycarboxylate ethers according to the invention is that the polyalkylene glycol side chains of the polymer are not pure polyethylene glycols or polypropylene glycols. Instead, the polyalkylene glycols are either random or block polyalkylene glycols comprising propylene oxide and ethylene oxide units.

The preparation of the polycarboxylate ethers according to the invention can be effected by means of free radical polymerization. The polymerization reaction can be carried out continuously, batchwise or semicontinuously.

The polycarboxylate ether according to the invention is a main-chain polymer and not a graft product.

The preparation of the polycarboxylate ethers according to the invention is possible only by the use of polyalkylene glycol monomethacrylates as monomers (A) which are prepared by DMC catalysis. Monomers (A) which were prepared by other processes have excessively high contents of dimethacrylates of polyalkylene glycol. In the polymerization, these dimethacrylates lead to crosslinked polymer structures which, owing to their high viscosity, cannot be employed in the fields of use described below.

Examples 6 and 7 show that the use of monomers (A) which were not prepared by means of DMC catalysis leads to unusable polycarboxylate ethers.

The polymerization reaction is preferably carried out as precipitation polymerization, emulsion polymerization, solution polymerization, mass polymerization or gel polymerization. Solution polymerization is particularly advantageous for the property profile of the copolymers according to the invention.

All organic or inorganic solvents which are very substantially inert with respect to free radical polymerization reactions, for example ethyl acetate, n-butyl acetate or 1-methoxy-2-propyl acetate, and alcohols, such as, for example, ethanol, isopropanol, n-butanol, 2-ethylhexanol or 1-methoxy-2-propanol, and likewise diols, such as ethylene glycol and propylene glycol, may serve as solvents for the polymerization reaction. Ketones, such as acetone, butanone, pentanone, hexanone and methyl ethyl ketone, alkyl esters of acetic, propionic and butyric acid, such as, for example, ethyl acetate, butyl acetate and amyl acetate, ethers, such as tetrahydrofuran, diethyl ether and ethylene glycol and polyethylene glycol monoalkyl ether and dialkyl ether, can also be used. Aromatic solvents, such as, for example, toluene, xylene or higher-boiling alkylbenzenes, may likewise be used. The use of solvent mixtures is also conceivable, the choice of the solvent or of the solvents depending on the intended use of the copolymer according to the invention. Water; lower alcohols; preferably methanol, ethanol, propanols, isobutanol, sec-butanol and tert-butanol, 2-ethylhexanol, butylglycol and butyldiglycol, particularly preferably isopropanol, tert-butanol, 2-ethylhexanol, butylglycol and butyldiglycol; hydrocarbons having 5 to 30 carbon atoms and mixtures and emulsions of the abovementioned compounds are preferably used.

The polymerization reaction is preferably effected in the temperature range from 0 to 180° C., particularly preferably from 10 to 100° C., both at atmospheric pressure and at elevated or reduced pressure. The polymerization can also optionally be carried out under an inert gas atmosphere, preferably under nitrogen.

High-energy, electromagnetic beams, mechanical energy or the customary chemical polymerization initiators, such as organic peroxides, e.g. benzoyl peroxide, tert-butyl hydroperoxide, methyl ethyl ketone peroxide, cumyl peroxide, dilauroyl peroxide (DLP), or azo initiators, such as, for example, azodiisobutyronitrile (AIBN), azobisamidopropyl hydrochloride (ABAH) and 2,2′-azobis(2-methylbutyronitrile) (AMBN), can be used for initiating the polymerization. Inorganic peroxy compounds, such as, for example, (NH₄)₂S₂O₈, K₂S₂O₈ or H₂O₂, optionally in combination with reducing agents (e.g. sodium hydrogen sulfite, ascorbic acid, iron(II) sulfate) or redox systems which contain an aliphatic or aromatic sulfonic acid (e.g. benzenesulfonic acid, toluenesulfonic acid) as reducing component are likewise suitable.

The customary compounds are used as chain-transfer agents for regulating the molecular weight. Suitable known chain-transfer agents are, for example, alcohols, such as methanol, ethanol, propanol, isopropanol, n-butanol, sec-butanol and amyl alcohols, aldehydes, ketones, alkylthiols, such as, for example, dodecylthiol and tert-dodecylthiol, thioglycolic acid, isooctyl thioglycolate, 2-mercaptoethanol, 2-mercaptopropionic acid, 3-mercaptopropionic acid, and some halogen compounds, such as, for example, carbon tetrachloride, chloroform and methylene chloride.

The polycarboxylate ethers according to the invention are preferably administered as 5-50% strength aqueous solution and particularly preferably as 20 to 45% strength aqueous solution, as dispersants, superplasticizers, sequestering agents or plasticizers, for the intended use.

A further administration form of the polycarboxylate ethers according to the invention is powders or granules, which are prepared by drying the polycarboxylate ether solutions obtainable after the polymerization.

The polycarboxylate ethers according to the invention are suitable as dispersants and superplasticizers for minerals, inorganic pigments, as dispersants for pigment preparations, tinting pastes for wall paints, printing inks, dispersants for pigment dispersions, e.g. titanium dioxide, calcium carbonate, kaolin, talc, dispersions in ceramic production, for the prevention of scale deposition, as additives for cleaning agents, as sequestering agents in the textile, paper and leather industry and as scale preventers for industrial water and in waste water treatment.

The polycarboxylate ethers according to the invention are suitable as plasticizers and superplasticizers for hydraulic cement systems, such as, for example, Portland cement, lime marl, concrete, screed mortar, gypsum suspensions and anhydrous calcium sulfate binder formulations, for ceramic materials comprising clays, kaolins, feldspars and quartz minerals, calcium stearate and the sparingly water-soluble fatty acid salts of further divalent and polyvalent cations.

The polycarboxylate ethers according to the invention are furthermore suitable as dispersants and deflocculants for inorganic pigments are, for example titanium dioxides, zinc sulfides, zinc oxides, iron oxides, magnetites, manganese iron oxides, chromium oxides, ultramarine, nickel or chromium antimony titanium oxides, manganese titanium rutiles, cobalt oxides, mixed oxides of cobalt and aluminum, rutile mixed-phase pigments, sulfides of the rare earths, spinels of cobalt with nickel and zinc, spinels based on iron and chromium with copper, zinc and manganese, bismuth vanadates and extender pigments. In particular, the colour index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33 and Pigment White 6 are used. Frequently, mixtures of inorganic pigments are also preferably used. Mixtures of organic with inorganic pigments are likewise frequently used. The pigment dispersions prepared with the aid of the polycarboxylate ethers according to the invention can be used as tinting pastes or pigment slurries, dispersions or preparations in the paint and coating industry, and the ceramic industry and, inter alia, in the textile and leather industry.

The polycarboxylate ethers according to the invention are used in particular as dispersants for transparent iron oxide pigments, with which transparent aqueous or solvent-containing coatings for wood coating can be prepared.

The polycarboxylate ethers according to the invention are preferably used in an amount of from 0.01 to 15% by weight, preferably 0.1 to 5% by weight, based on the weight of the inorganic pigments, including hydraulic binders, hydrated calcium sulfate (building industry) and the previously described minerals and inorganic pigments. In particular, 0.1-10% by weight and preferably 0.3-5% by weight, based on the inorganic pigments, are used for dispersing inorganic pigments in paints and coatings, pigment concentrates, slurries and pigment preparations.

A particular embodiment of the polycarboxylate ethers according to the invention is the use as dispersant in aqueous emulsion paints. Aqueous emulsion paints contain various white pigments, in particular titanium dioxide, barium sulfate and zinc sulfite, colored pigments as described above, in particular iron oxide pigments, chromium dioxide and cobalt spinel pigments, fillers, such as natural or precipitated calcium carbonate, talc, kaolin, quartz powder and other mineral pigments. Emulsion polymers are used as binders for the white pigments and fillers. These emulsion polymers usually consist of polymers or copolymers of styrene, acrylates, methacrylates, acrylic acid, methacrylic acid, maleic diesters, vinyl acetate, vinyl isodecanoate, vinyl neodecanoate, vinyl isononanoate, vinyl chloride, butadiene and other olefinically unsaturated monomers. Further binders are aqueous alkyd resin dispersions, polyurethane dispersions, potassium waterglass for silicate paints, silicone resin dispersions and further aqueous polymer dispersions.

Usually, the polycarboxylates according to the invention are added to the aqueous paint in amounts of 0.05-5% by weight, based on the inorganic pigments and fillers, and, in a preferred form, in amounts of 0.1-1% by weight, based on the inorganic pigments and fillers.

Additives for scale prevention are used in industrial and waste waters, in the textile, leather and paper industry and in household and industrial cleaners. The polycarboxylate ethers according to the invention are suitable as dispersants and sequestering agents for alkaline earth metal carbonates and sulfates which are sparingly soluble in water. Suitable amounts used are 0.001-0.1% by weight of polycarboxylate ethers in industrial waters and waste waters or 0.01-2% by weight of polycarboxylate ethers, based on the liquors used in the textile, leather and paper industry or in the hygiene sector.

The polycarboxylate ethers according to the invention are suitable in particular for use in the pretreatment, bleaching, desizing, boiling, mercerization of textiles, in particular of woven textile fabrics comprising cotton, linen, wool and manmade fibers and blended fabrics thereof, and for textile dyeing and high-grade finishing. Particularly in pretreatment and bleaching, the polycarboxylate ethers according to the invention are suitable for preventing deposits on the woven fabrics and the machine elements.

The polycarboxylate ethers according to the invention are also suitable for the preparation of liquid cleaning formulations which contain anionic, nonionic, amphoteric and cationic surfactants, the carboxylate ether according to the invention having the function of preventing the formation of scale in the liquor used. Possible examples of the use of the polycarboxylate ethers according to the invention are vehicle care agents, industrial cleaners, dairy cleaners, butchers' cleaners, household floor care agents, dishwashing agents, liquid and pulverulent household detergents for textiles, sanitary cleaners, toilet cleaners and other cleaners in the household sector and in the commercial or industrial sector.

Usually, polymers of acrylic acid, copolymers of maleic acid and acrylic acid or chelating agents, such as aminotriacetic acid, ethylenediaminetetraacetate, aminotrismethylenephosphonic acid, diethylenetriaminepentamethylene-phosphonic acid, 1-hydroxyethane-1,1-diphosphonic acid and the sodium and potassium salts thereof, which, owing to their ionic characters, are not very miscible with surfactants, are used as limestone preventers. The polycarboxylates according to the invention on the other hand are distinguished by good compatibility with anionic, nonionic, amphoteric and cationic surfactants and are therefore suitable for the preparation of liquid cleaning agent formulations.

A further use of the polycarboxylate ethers according to the invention as dispersants for abrasives, e.g. for silicon carbide, is suitable for the chemical mechanical planarization of silicon wafers.

Further applications of the polycarboxylate ethers according to the invention as dispersants and limestone preventers are crop protection formulations, cooling lubricants in metal processing, waste water treatment, mineral oil extraction, mineral oil cracking and ore dressing.

If appropriate, the polycarboxylate ethers according to the invention are combined in combination with further surface-active substances. The aim of this combination is an improvement in the properties of the use formulation. Suitable surface-active substances may be, for example, air void formers and wetting agents in the building industry and further wetting and dispersing additives in the paint and coating industry and for pigment preparations, slurries or dispersions.

Thus, in preferred embodiments, the use formulations according to the invention optionally contain one or more nonionic surfactants from the group consisting of the alkylphenolpolyethylene glycol ethers, styrene-substituted phenolpolyethylene glycol ethers, alkylpolyethylene glycol ethers, alkylamine ethoxylates of primary alkylamines having a carbon chain length of 8 to 22 carbon atoms, fatty acid polyethylene glycol ethers, fatty acid polyglycosides, alkylpolyalkylglycol ethers of C₈-C₂₂-alcohols which were reacted blockwise with ethylene oxide and propylene oxide, endcapped alkyl ethoxylates of C₈-C₂₂-alcohols which were reacted with ethylene oxide and were etherified with methyl chloride, butyl chloride or benzyl chloride, ethylene/propylene glycol block polymers and sorbitan ester polyethylene glycol ethers.

In a further preferred embodiment, the use formulations according to the invention optionally contain one or more anionic surfactants from the group consisting of the sodium, potassium and ammonium salts of fatty acids, sodium alkylbenzenesulfonates, sodium alkylsulfonates, sodium olefinsulfonates, sodium polynaphthalenesulfonates, sodium ligninsulfonate, sodium dialkyldiphenyl ether disulfonates, sodium, potassium and ammonium alkylsulfates, sodium, potassium and ammonium alkylpolyethylene glycol ether sulfates, sodium, potassium and ammonium alkylphenolpolyethylene glycol ether sulfates, sodium, potassium and ammonium mono- and dialkylsulfosuccinates and monoalkylpolyoxethyl-sulfosuccinates, and alkylpolyethylene glycol ether phosphoric acid mono-, di- and triesters and mixtures thereof and alkylphenolpolyethylene glycol ether phosphoric acid mono-, di- and triesters and mixtures thereof and the sodium, potassium and ammonium salts thereof, alkylpolyethylene glycol ether carboxylic acids and the sodium, potassium and ammonium salts thereof, sulfuric monoesters and phosphoric esters of styrene-substituted phenol ethoxylates, styrene-substituted phenolpolyethylene glycol ether carboxylic acids and their sodium, potassium and ammonium salts, sodium fatty acid isethionates, sodium fatty acid methyltaurides and sodium fatty acid sarcosides.

In a further preferred embodiment, the use formulations according to the invention optionally contain one or more solvents, hydrotropic substances, viscosity modifiers or humectants selected from the group consisting of the glycol ethers, in particular polyethylene glycol ether or polypropylene glycol ether having an average molar mass of from 200 to 2000 g/mol, mono-, di- or triethylene glycol, mono-, di- or tripropylene glycol, methyl-, ethyl-, propyl- or butylpolyalkylene glycol ethers or higher-functional alkylpolyalkylene glycol ethers having 1, 2, 3 or more ethylene glycol or propylene glycol units, such as, for example, methoxypropanol, dipropylene glycol monomethyl ether, tripropylene glycol monomethyl ether, ethylene glycol monobutyl ether, diethylene glycol monobutyl ether, butylpolyethylene glycol ether, propylpolyethylene glycol ether, ethylpolyethylene glycol ether, methylpolyethylene glycol ether, dimethylpolyethylene glycol ether, dimethylpolypropylene glycol ether, glyceryl ethoxylates having a molecular weight of from 200 to 20 000 g/mol, pentaerythrityl alkoxylates and further ethoxylation and alkoxylation products and random or block copolymers which were prepared by an addition reaction of ethylene oxide and/or propylene oxides with monohydric and higher-hydric alcohols.

Further water-soluble organic or hydrotropic substances which can be combined with the copolymers according to the invention and which optionally also serve as solvents, consistency regulators or rheology additives are, for example, formamide, urea, tetramethylurea, E-caprolactam, glycerol, diglycerol, polyglycerol, N-methylpyrrolidone, 1,3-diethyl-2-imidazolidinone, thiodiglycol, sodium benzenesulfonate, sodium xylenesulfonate, sodium toluenesulfonate, sodium cumenesulfonate, sodium dodecylsulfonate, sodium benzoate, sodium salicylate, sodium butyl monoglycol sulfate, gelatin derivatives, cellulose derivatives, such as, for example, methylcellulose, hydroxyethylcellulose ether, methoxyethylcellulose ether, methoxypropylcellulose ether, polyvinylpyrrolidone, polyvinyl alcohol, polyvinylimidazole and co- and terpolymers of vinylpyrrolidone, vinyl acetate and vinylimidazole, it being possible for the polymers having vinyl acetate building blocks subsequently to be subjected to hydrolysis to the vinyl alcohol.

Antisettling agents, light stabilizers, antioxidants, degassing agents/antifoams, foam-reducing agents, fillers, milling auxiliaries, viscosity stabilizers and additives which advantageously influence the rheology are suitable as further customary additives. For example, starch derivatives and cellulose derivatives and hydrophobically modified ethoxylated urethane (HEUR) thickeners are suitable as agents for regulating the viscosity. Suitable pH regulators are organic or inorganic bases and acids. Preferred organic bases are amines, such as, for example, ethanolamine, diethanolamine, triethanolamine, N,N-dimethylethanolamine, diisopropylamine, aminomethylpropanol or dimethylaminomethylpropanol. Preferred inorganic bases are sodium, potassium or lithium hydroxide or ammonia.

### SYNTHESIS EXAMPLES

### Example 1

### Synthesis of the Macromonomer (A)

0.625 mol (90 g) of hydroxypropyl methacrylate and 0.045 g of 2,2,6,6-tetramethylpiperidin-1-oxyl and 0.045 g of the DMC catalyst described in EP-A-1 276 563 are initially introduced into a pressure-resistant reactor. The mixture is heated to a temperature to 120° C. under nitrogen and an amount of 36.3 g of propylene oxide is metered in at a pressure of about 3 bar so that the resulting heat of reaction can be removed. After the reaction of the propylene oxide, detectable by the pressure drop, 330 g of ethylene oxide are metered in again so that the resulting heat of reaction can be removed. After the reaction, detectable by the pressure drop to the starting pressure, the product is analyzed by means of OH number titration, NMR spectroscopy and GPC molar mass determination.

| OH number | Calculated | | GPC |
|---|---|---|---|
| in mg | molar | | characterization |
| KOH/g | mass Mn | NMR molar ratio from | (lipophilic GPC |
| according | from OH | ¹H NMR signals | in THF |
| to | number in | double bond | with PEG |
| DIN 53240 | g/mol | methacrylate:PO:EO:CH₂OH | calibration) |
| 74.3 | 755 | 1:2.1:12.3:1.03 | a main peak |
| | | | >92% |
| | | | with maximum |
| | | | at 720 g/mol |

A methacrylate-(PO)₂(EO)₁₂-OH block copolymer has thus formed.

### Example 2

### Synthesis of the Macromonomer (A)

0.625 mol (90 g) of hydroxypropyl methacrylate and 0.045 g of 2,2,6,6-tetramethylpiperidin-1-oxyl and 0.045 g of the DMC catalyst described in EP-A-1 276 563 are initially introduced into a pressure-resistant reactor. The mixture is heated to a temperature to 110° C. under nitrogen and an amount of 36.3 g of propylene oxide is metered in at a pressure of about 3 bar so that the resulting heat of reaction could be removed. After the reaction of the propylene oxide, detectable by the pressure drop, 1100 g of ethylene oxide are metered in again so that the resulting heat of reaction can be removed. After the reaction, detectable by the pressure drop to the starting pressure, the product is analyzed by means of OH number titration, NMR spectroscopy and GPC molar mass determination.

| | Calculated | | |
|---|---|---|---|
| OH number | molar mass | NMR molar ratio from | |
| in mg KOH/g | Mn from OH | ¹H NMR signals | GPC characterization |
| according to | number in | double bond | (lipophilic GPC in THF with PEG |
| DIN 53240 | g/mol | methacrylate:PO:EO:CH₂OH | calibration) |
| 28.8 | 1947 | 1:2.1:40:1.15 | a main peak |
| | | | >90% with |
| | | | maximum at |
| | | | 1700 g/mol |

A methacrylate-(PO)₂(EO)₄₀-OH block copolymer has thus formed.

### Example 3

### Synthesis of the Polycarboxylate Ether

The macromonomer (A) from Example 1 (360 g), methacrylic acid (40 g), monoallylpolyethylene glycol (molar mass=250 g/mol) (22.3 g) and 1-dodecylthiol (17.1 g) in 400 g of isopropanol are initially introduced under nitrogen into a glass flask. Heating to a temperature of 80° C. is then effected with stirring. After the reaction temperature has been reached, the initiator AMBN (9.15 g dissolved in 36.6 g of isopropanol) is metered in in the course of 1 hour. Stirring is then effected for a further 5 hours at this temperature. After cooling to room temperature, the solvent is removed in vacuo.

### Example 4

### Synthesis of the Polycarboxylate Ether

The macromonomer (A) from Example 2 (50% by weight in water, 432.6 g), methacrylic acid (11.4 g), sodium methallylsulfonate (22.4 g) and 2-mercapto-propionic acid (1.6 g) in water (198.3 g) are initially introduced under nitrogen into a glass flask. The reaction mixture is then heated to 75° C. and sodium persulfate (6.35% by weight in water, 34.4 g) is metered in. After complete addition, stirring is effected for a further hour at 75 ° C. Thereafter, cooling to room temperature is effected and the pH is adjusted to 5.5 with sodium hydroxide solution (50% by weight in water).

### Example 5

### Synthesis of the Polycarboxylate Ether

The macromonomer (A) from Example 2 (50% by weight in water, 432.6 g), methacrylic acid (54.1 g), sodium methallylsulfonate (22.4 g) and 2-mercapto-propionic acid (1.6 g) in water (198.3 g) are initially introduced under nitrogen into a glass flask. The reaction mixture is then heated to 75° C. and sodium persulfate (6.35% by weight in water, 34.4 g) is metered in. After complete addition, stirring is effected for a further hour at 75 ° C. Thereafter, cooling to room temperature is effected and the pH is adjusted to 6 with sodium hydroxide solution (50% by weight in water).

### Example 6

Comparative Example—Synthesis of a polycarboxylate ether with Bisomer PEM 6LD (polyethylene glycol monomethacrylate, 6 EO units, manufacturer: Cognis) Bisomer PEM 6LD (360 g), methacrylic acid (40 g) and 1-dodecanethiol (15.11 g) in 400 g of isopropanol are initially introduced under nitrogen into a glass flask. Heating to a temperature of 80° C. is then effected with stirring. After reaching the reaction temperature, the initiator AMBN (14.33 g dissolved in 57.32 g of isopropanol) is metered in in the course of 1 hour. Only a short time after complete addition of initiator, a viscous gel forms, which indicates strong crosslinking of the polymer.

### Example 7

Comparative Example—Synthesis of a polycarboxylate ether with Bisomer PEM 6LD (polyethylene glycol monomethacrylate, 6 EO units, manufacturer: Cognis) Bisomer PEM 6LD (392 g), methacrylic acid (8 g) and 1-dodecanethiol (12.27 g) in 400 g of isopropanol are initially introduced under nitrogen into a glass flask. Heating to a temperature of 80° C. is then effected with stirring. After reaching the reaction temperature, the initiator AMBN (11.64 g dissolved in 46.6 g of isopropanol) is metered in in the course of 1 hour. Only a short time after complete addition of initiator, a viscous gel forms, which indicates strong crosslinking of the polymer.

### Use Examples

In the following examples, percentages stated are percentages by weight, unless stated otherwise.

### Use Example 1

### Preparation of a Titanium Dioxide Dispersion

0.5 g of the aqueous solution of the polycarboxylate ether from Example 4 is predissolved in 49.5 g of demineralized water and then 150 g of titanium dioxide (Hombitan® titanium dioxide R 210, Sachtleben Chemie GmbH) are dispersed therein using a toothed dissolver disk. The resulting pigment suspension has a Brookfield viscosity of 440 mPa·s (spindle 4, 100 rpm).

### Use Example 2

### Preparation of a Calcium Carbonate Dispersion

0.5 g of the aqueous solution of the polycarboxylate ether from Example 4 is predissolved in 49.5 g of demineralized water and then 150 g of calcium carbonate (Omyacarb® 2 GU, Omya AG) are dispersed therein using a toothed dissolver disk. The resulting pigment suspension has a Brookfield viscosity of 240 mPa·s (spindle 4, 100 rpm).

### Use Example 3

### Preparation of an Emulsion Paint

124 g of demineralized water are initially introduced and 2 g of thickened based on methoxyethylcellulose ether (Tylose® MH 10000 YP2, SE Tylose GmbH), 5 g of the aqueous solution of the polycarboxylate ether from Example 5, according to the invention, 2 g of wetting agent (Genapol® ED 3060, Clariant International AG) and 2 g of antifoam and deaerator (Antimussol® W-06, Clariant International AG) are dissolved therein with stirring. Thereafter, in powder form, 220 g of titanium dioxide (titanium dioxide Kronos® 2169, Kronos Titan GmbH), 170 g of calcium carbonate (Omyacarb® 5 GU, Omya AG), 40 g of talc (Plastorit® 00 Micro talc AT 1, Luzenac Naintsch) and 20 g of kaolin (White Grown Clay, Omya AG) are added to the dispersion liquor and dispersed by means of a toothed ring at 3000 revolutions per minute. Thereafter, 2 g of 25% strength aqueous ammonia solution (buffer solution), 12 g of butyldiglycol (coalescence agent), 375 g of pure acrylate polymer disperion (Mowilith® LDM 7714, Celanese Emulsions GmbH), 2 g of biocide solution (Nipacide® BIT 10, Clariant International AG) and 4 g of hydrophobically modified ethoxylated urethane thickener (Tafigel® PUR 40, Münzing GmbH) are added and homogenized at low speeds of 500 revolutions per minute using the toothed ring. The resulting emulsion paint has a viscosity of about 110 Pa·s and is stable and readily spreadable after storage at 60° C. for one week.

### Use Example 4

### Preparation of a Pigment Preparation with Iron Oxide Red

70 parts of C.I. Pigment Red 101 (Bayferrox® 130, Lanxess AG, component A)

7 parts of aqueous solution of the polycarboxylate ether from Example 3 (component B, dispersant)

10 parts of humectant (Polyglycol 300, Clariant International AG, component C, dispersant)

0.2 part of preservative (Nipacide® BIT 10, Clariant International AG, component D)

0.5 part of antifoam (Antimussol® W-06, Clariant International AG, component E)

12.3 parts of demineralized water (component F)

The components (B), (C), (D), (E) and (F) are initially introduced into a milling container and mixed. Thereafter, the pulverulent component (A) is added and is predispersed using the dissolver. The fine dispersing is effected in a bead mill by means of zirconium mixed oxide beads of size d=1 mm with cooling. Thereafter, the grinding medium is separated off and the pigment preparation is isolated. The pigment preparation is stored for one week at 60° C. and assessed visually. The viscosity of the pigment preparation is measured using a Brookfield digital viscometer model DV-II at 100 revolutions per minute with spindle 4.

The pigment preparation is fluid, homogeneous and foam-free after storage for one week at 60° C. The viscosity of the pigment preparation is 2400 mPa·s.

### Use Example 5

### Preparation of a Pigment Preparation with Iron Oxide Black

65 parts of C.I. Pigment Black 11 (Bayferrox® 316, Lanxess AG, component A)

7 parts of aqueous solution of polycarboxylate ether from Example 3 (component B, dispersant)

10 parts of humectant (Polyglycol 300, Clariant International AG, component C)

0.2 part of preservative (Nipacide® BIT 10, Clariant International AG, component D)

0.5 part of antifoam (Antimussol® W-06, Clariant International AG, component E)

12.3 parts of demineralized water (component F)

The pigment preparation is prepared and tested as described in Use Example 4.

The pigment preparation is fluid, homogeneous and foam-free after storage for one week at 60° C. The viscosity of the pigment preparation is 3400 mPa·s.

### Use Example 6

### Preparation of a Pigment Preparation with Transparent Iron Oxide Red Pigment

30 parts of C.I. Pigment Red 101 (Sicotrans® Red L 2715 D, BASF AG, component A)

6 parts of aqueous solution of the polycarboxylate ether from Example 3 (component B, dispersant)

10 parts of humectant (Polyglycol 300, Clariant International AG, component C)

0.2 part of preservative (Nipacide® BIT 10, Clariant International AG, component D)

0.5 part of antifoam (Antimussol® W-06, Clariant International AG, component E)

53.3 parts of demineralized water (component F)

The pigment preparation is prepared and tested as described in Use Example 4. The pigment preparation is fluid, homogeneous and foam-free after storage for one week at 60° C. The viscosity of the pigment preparation is 80 mPa·s.

### Use Example 7

### Preparation of a Pigment Preparation with Transparent Iron Oxide Yellow Pigment

30 parts of C.I. Pigment Yellow 42 (Sicotrans® Yellow L1918, BASF AG, component A)

6 parts of aqueous solution of the polycarboxylate ether from Example 3 (component B, dispersant)

10 parts of humectant (Polyglycol 300, Clariant International AG, component C) 0.2 part of preservative (Nipacide® BIT 10, Clariant International AG, component D)

0.5 part of antifoam (Antimussol® W-06, Clariant International AG, component E)

53.3 parts of demineralized water (component F)

The pigment preparation is prepared and tested as described in Use Example 4. The pigment preparation is fluid, homogeneous and foam-free after storage for one week at 60° C. The viscosity of the pigment preparation is 110 mPa·s.

### Use Example 8

### Preparation of a Cement Mortar

900 g of Portland cement are stirred with 2700 g of standard sand (coarse fraction:fine fraction=2:1) and 450 g of water which contains the polycarboxylate ether according to the invention in predissolved form, in accordance with the standard. With the use of 0.25% of polycarboxylate ether, from Example 5, based on the Portland cement (2.25 g of active substance), the cement mortar is still flowable even after 90 minutes. The cement mortar without polycarboxylate ether is stiff and non-flowable even immediately after preparation.

### Novel Examples

### Use Example 9

### Preparation of a Universal Cleaner

10 g of the aqueous solution of the polycarboxylate ether from Example 3, 10 g of isotridecylpolyethylene glycol ether with 8 mol of ethylene oxide (Genapol® X 080, Clariant International AG), 20 g of mono/diphosphoric ester of an alkylpolyethylene glycol ether with 6 mol of ethylene oxid (Hostaphat® 1306, Clariant International AG), 2 g of a 25% strength aqueous ammonia solution and 168 g of demineralized water are mixed in a beaker. The solution has a pH of about 5, is stable and fluid at room temperature and is suitable as a universal cleaner for hard surfaces.

### Use Example 10

### Preparation of a Pigment Preparation with Transparent Iron Oxide Yellow Pigment

50 parts of C.I. Pigment Yellow 42 (Sicotrans® Yellow L1918, BASF AG, component A)

8 parts of aqueous solution of the polycarboxylate ether from Example 3 (component B, dispersant)

10 parts of humectant (Polyglycol 300, Clariant International AG, component C)

0.2 part of preservative (Nipacide® BIT 10, Clariant International AG, component D)

0.5 part of antifoam (Antimussol® W-06, Clariant International AG, component E)

31.3 parts of demineralized water (component F)

The pigment preparation is prepared and tested as described in Use Example 4. The pigment preparation is fluid, homogeneous and foam-free after storage for one week at 60° C. The viscosity of the pigment preparation is 240 mPa·s.

### Use Example 11

### Preparation of a Pigment Preparation with Transparent Iron Oxide Red Pigment

50 parts of C.I. Pigment Red 101 (Sicotrans® Red L 2715 D, BASF AG, component A)

8 parts of aqueous solution of the polycarboxylate ether from Example 3 (component B, dispersant)

10 parts of humectant (Polyglycol 300, Clariant International AG, component C)

0.2 parts of preservative (Nipacide® BIT 10, Clariant International AG, component D)

0.5 parts of antifoam (Antimussol® W-06, Clariant International AG, component E)

31.3 parts of demineralized water (component F)

The pigment preparation is prepared and tested as described in Use Example 4. The pigment preparation is fluid, homogeneous and foam-free after storage for one week at 60° C. The viscosity of the pigment preparation is 2500 mPa·s.

1. A process for the preparation of a polycarboxylate ether comprising the step of polymerizing a macromonomer (A) and the monomers (B) and (C), wherein
(A) is a macromonomer of the formula (I) 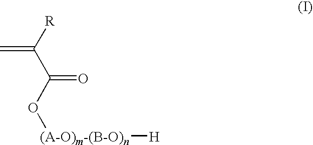
wherein
A is C₂- to C₄-alkylene,
B is a C₂- to C₄-alkylene differing from A,
R is hydrogen or methyl,
m is a number from 1 to 500,
n is a number from 1 to 500,
and where the macromonomer (A) is prepared with at least one DMC (double metal cyanide) catalyst,
(B) is an ethylenically unsaturated monomer which contains at least one carboxyl function, and
(C) is a further, water-soluble, ethylenically unsaturated monomer differing from (A) and (B).

2. A process as claimed in claim 1, wherein the proportion by weight of the macromonomer (A) is from 35 to 99%.

3. A process as claimed in claim 1, wherein the proportion by weight of the monomer (B) is from 0.5 to 45%.

4. A process as claimed in claim 1, wherein the proportion by weight of the monomer (C) is from 0.5 to 20%.

5. A process as claimed in claim 1, wherein the compound of the formula (I) contains ethylene oxide and propylene oxide units, and the molar proportion of the ethylene oxide units being from 50 to 99%, based on the sum (100%) of the ethylene oxide and propylene oxide units.

6. A process as claimed in claim 1, wherein m is a number from 1 to 150.

7. A process as claimed in claim 1, wherein n is a number from 3 to 300.

8. A process as claimed in claim 1, wherein the sum of the alkylene oxide units n+m is from 2 and 500.

9. A process as claimed in claim 1, wherein the macromonomer (A) is prepared by reaction of conjugated unsaturated acids or reactive derivatives, such as conjugated unsaturated hydroxyalkyl esters, with alkylene oxides in the presence of catalysts of the formula Zn₃[Co(CN)₆]₂.xZnCl₂.yH₂O.z glyme, where x=0.2 to 3, y=1 to 10 and z=0.5 to 10.

10. A process as claimed in claim 1, wherein the monomer (B) is selected from the group consisting of monoethylenically unsaturated mono- and dicarboxylic acids having 3 to 8 carbon atoms.

11. A process as claimed in claim 1, wherein the monomer (C) is selected from the group consisting of monoethylenically unsaturated sulfonic acids and salts thereof, phosphonic acids and salts thereof, and monoallylpolyalkylene glycols.

12. A process as claimed in claim 1, wherein the polycarboxylate ether according to the invention have a molecular weight of from 10³ g/mol to 10⁹ g/mol.

13. A polycarboxylate ether containing structural units of the macromonomer (A), and monomers (B) and (C),
(A) being a macromonomer of the formula (I) 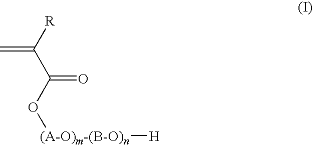
wherein
A is C₂- to C₄-alkylene,
B is a C₂- to C₄alkylene differing from A,
R is hydrogen or methyl,
m is a number from 1 to 500,
n is a number from 1 to 500,
and where the macromonomer (A) is prepared with at least one DMC (double metal cyanide) catalyst,
(B) is an ethylenically unsaturated monomer which contains at least one carboxyl function, and
(C) is a further, ethylenically unsaturated monomer differing from (A) and (B).
